(19) United States
(12) Patent Application Publication
(10) Pub. No.: US 2019/0318539 A1
(43) Pub. Date: Oct. 17, 2019

(54) SMART TRACKING SYSTEM

(71) Applicant: INFINITE KINGDOMS LLC, Wakefield, RI (US)

(72) Inventor: Denise Chapman Weston, WAKEFIELD, RI (US)

(73) Assignee: INFINITE KINGDOMS LLC, Wakefield, RI (US)

(21) Appl. No.: 16/382,472

(22) Filed: Apr. 12, 2019

Related U.S. Application Data
(60) Provisional application No. 62/657,166, filed on Apr. 13, 2018.

(51) Int. Cl. G06T 19/00; H04L 29/08; H04W 4/021

(52) U.S. Cl. CPC G06T 19/003; G06T 19/006; A63G 31/00; H04L 67/22; H04W 4/021; H04L 67/306

(57) ABSTRACT

Like a Choose-Your-Own-Adventure Book, the infinite tracking system allows for an amusement park ride or attraction to identify a user or participant based on unique characteristics, track them throughout the ride or attraction, and modify the experience based on the user or participant's chosen preferences. For example, a user or participant may choose outer space as their preferred theme. The tracking system may employ a variety of sensors to identify and distinguish the user or participant based on characteristics such as their physical size and clothing, and locates them throughout the amusement park ride or attraction. The system associates the outer space theme preference with the user or participant. As the user or participant travels throughout the amusement park ride or attraction, the system displays relevant effects, and the user or participant enjoys a unique and customized visual, audio, and physical experience that features their preferred theme.

### TECHNICAL FIELD

This disclosure generally relates to unobtrusive tracking and customization techniques for theme parks and other entertainment-based properties.

### BACKGROUND

The increased availability and technological advancement of video game systems, virtual reality systems, and other technology-based entertainment systems have increased access to in-home entertainment options at affordable prices. These systems often provide users with an interactive digital world that is increasingly customizable to the user's liking. This has increased user engagement and satisfaction with those systems. For example, some video games provide users with the ability to customize the appearance and physical attributes of their player. As another example, users customize environments, weapons, spells, charms, or various other interactive traits for use during game play. Some video games leverage an internet connection to create a virtual world where players interact with each other, accomplish game objectives together, and socialize.

Some of this expansion has come at the expense of theme parks and other real-world attractions. This is due in part to pricing, marketing, and accessibility. For example, a family can provide an entertaining interactive experience at home by purchasing a video game system or virtual reality system for, in many cases, less than the cost of travel to an amusement park. Amusement parks are generally located in rather remote regions while urban expansion is booming in most major metropolitan cities. Taking time off of work is also increasingly difficult for modern families. Accordingly, many families seek to invest more in in-home entertainment experiences rather than saving for vacations to theme parks.

The broad appeal of in-home entertainment systems is owed somewhat to the customized nature of the experiences they provide. For example, by rewarding a particular user's investments, including time, mental, and in some cases financial investment, in accomplishing missions or performing certain challenges, these systems create a relationship with the user, causing the user to return to engage in additional challenges within the game or purchase additional game titles within a particular franchise. However, in order to customize and reward user investment and accomplishments in virtual game environments, these systems rely on mechanisms that monitor and store user data related to their game playing activities. Traditional barriers to tracking real-world user activities are obviated by the online digital video game environments. For example, a game console stores a user login and password and automatically signs in for the user upon booting a particular game. Moreover, consoles may have unique identifiers that make attributing user actions in an online gaming environment to a particular user a trivial task.

However, people often desire to engage in interactive entertainment experiences in real-world environments. And more and more people are coming to realize certain negative side effects of the increased adoption of in-home entertainment systems. For example, the video game industry has been accused of encouraging addictive lazy behavior in children. Bringing online virtual words to real-word scenarios may increase physical activity levels of players and eliminate or reduce these concerns. Moreover, certain real-world interactive experiences allow players to interact with their favorite video game or movie franchises in virtually enumerable ways. These additional avenues for engaging with users present a tremendous benefit to encouraging user engagement and interaction and improving user enjoyment.

Theme parks are ideally suited to capitalize on this desire. For example, some of the appeal of video game systems can be adapted for use in theme parks and real entertainment-based parks, and the user experience from video games can be extended to real world physical environments at a park. However, barriers for unobtrusive mechanisms to track user behaviors in real world environments remain high. Additionally, it has traditionally been difficult to apply information learned about a user from virtual environments (previous game play experience, customizations, and accomplishments) to enhance or customize real world experiences.

### BRIEF DESCRIPTION OF THE DRAWINGS

FIG. 1 illustrates an example block diagram reflecting the collection of tracking information in accordance with a non-limiting embodiment of the present disclosure.

FIG. 2 illustrates a high-level block diagram of a computer system.

FIG. 3 illustrates an example flow chart for recognizing and reacting to tracking information in accordance with a non-limiting embodiment of the present disclosure.

FIG. 4 illustrates one example implementation of a smart tracking system for identifying participants, their activities, and other supplemental or enhancement objects from image or video data in accordance with a non-limiting embodiment of the present disclosure.

FIGS. 5A-D illustrate examples of customizable objects that can be energized, tracked, and used to provide supplemental tracking information in accordance with a non-limiting embodiment of the present disclosure.

FIG. 6 illustrates an example sequence diagram of a smart tracking system implemented in a theme park in accordance with a non-limiting embodiment of the present disclosure.

### DESCRIPTION OF EXAMPLE EMBODIMENTS

### Introduction

The present invention relates to an improved system for tracking the movements, activities, and commands of participants without the need for electronic components or sensors carried by the participant or incorporated into objects carried by the participant, whereby the tracking system can use cameras, scanners, scales, other biometric analyzers or the like to detect the presence and activity of a participant based on their physical characteristics, dress, and the gestures or motions of the participant. The tracking system can be incorporated into physical locations, screens, virtual reality, augmented reality, or mixed reality experiences, including smart rooms or rides such as roller coaster, water rides, and water slides. For example, the tracking system could be incorporated into the presently-existing MAGIQUEST gaming experience. Certain configurations of the embodiments described in the present disclosure may be referred to herein as “smart tracking systems,” “Infinity Tracking,” “Infinite Tracking,” or the like.

In a preferred embodiment, tracking information can be identified at the entrance to an interactive entertainment attraction. For example, the participant may stand in front of a recognition station, whereby the tracking system utilizes devices such as cameras, scales, scanners, etc. to measure the participants' profile, height, weight, hair color, clothing color, shoes, etc. For example, if a guest is 5′ 9″, wearing a red shirt, blue pants, a black belt and white tennis shoes, player recognition files with those attributes will be created for that participant. Such data will not be accessed for other participants during the next 24 hours by the tracking system. On the rare occasion that there are duplicate sets of data, the system may be programmed to identify other distinguishing characteristics.

The participant can enhance the tracking information by carrying supplemental objects, such as photon blasters (toy guns) magnifying glasses, pens, paintbrushes, and other objects that the tacking system will recognize and “energize”. Unlike objects in presently-existing interactive environments, the objects can be simple and do not need to have tags or electronics within them. The interactive environment will be programmed to recognize what the object can do and, upon the requisite gesture or motion, show the appropriate effect (e.g., spell, laser or bullet) that would emanate from the object. The participant may also use other technologies embedded or incorporated in the item (as in presently-existing objects) to create other uniqueresults.

The tracking information can be further supplemented by the participant completing a participant profile (either on-site, on-line, or off-site). This participant could create a sticker that includes a bar card, QR code, or other representation that can be read to call up the participant's profile, which can then be used to enhance the interactive experience, on-site, at home, or elsewhere.

In addition, the participants' profile can be supplemented or enhanced by completing certain tasks, accomplishing goals, or reaching certain destinations. For example, if a participant completes a certain task, they may receive an enhancement to their profile, such as a choice of vehicle (real or virtual), character, clothing weapon, armor, enhanced abilities, special missions or quests, or additional points, gold, or other items of value.

The experience can be further enhanced by wearing goggles that allow the participant to see themselves in a virtual or augmented experience. For example, based on a participant's tracking profile, the participant's environment would appear as if they are riding on a certain dragon with special abilities, and the participant could interact with the environment depending on the items they have accumulated.

### General Overview

The teachings of the present disclosure describe systems and methods for unobtrusive identification, monitoring, and storing of user activities in a real-world environment. In particular embodiments, the teachings of the present disclosure are particularly applicable in the context of a theme park, amusement park, nature park, aquarium, zoo, or other real-world entertainment attractions. The approaches described herein describe systems and methods for unobtrusive data collection, storage, and aggregation regarding user interactions at these attractions. This data can be integrated with additional data collected from a user in order to enhance real and virtual user experiences. For example, a user may have extensive history playing a particular video game. The user's data from his or her play of that game can be automatically associated with a user at a real-world entertainment attraction. The user's game play data can be integrated with his or her real-world experience in order to customize the real-world experience in a manner that increases his or her satisfaction of both the real and virtual world experiences. For example, the real-world experience may include virtual smart attractions that enable customization for each individual user or group. Thus, a single ride can be converted from a static monolithic experience tailored to one specific target user at design time, to a dynamic customizable experience with nearly limitless options.

The teachings of the present disclosure describe systems for unobtrusive identification of users and linking of historical user data, unobtrusive tracking of user actions within a real-world environment, privacy mechanisms for easy adoption or declining (opting-out) of monitoring, customization techniques for customizing real-world attractions based on previous user data, and integration techniques for integrating both historical and monitored user data with other systems to increase user engagement. It should be noted that this data may be anonymized, encrypted, and stored in a manner that reduces or eliminates the possibility of mapping the data to a particular user.

In certain embodiments, a system begins seamlessly tracking theme park guests at various points pre-visit and during their park visit without the need of any devices, wearables or special items. It allows them to upgrade, play and ride attractions with special content they create and engage in at home, on an app, around the park, around a resort, in the queue line and on the ride. The systems discussed herein may be referred to as “Infinity Tracking” for marketing purposes.

The teachings of the present disclosure describe a system and method for tracking participants and objects within an interactive environment through the use of cameras, scales, sensors, and the like to detect the physical presence and characteristics of the participant and objects, instead of transmitters, chips, or other electronics embedded within components carried by the participants. The tracking system provides for an enhanced entertainment experience by using physical presence and characteristics to distinguish between participants and objects, and to provide for interactive responses based on the motion or activity of the participants or associated objects.

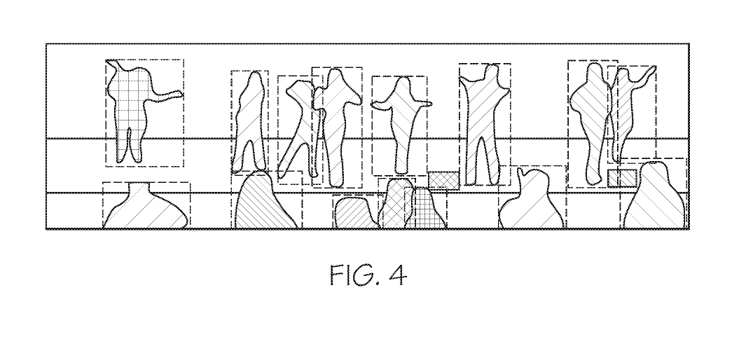

As depicted in FIG. 4, a smart tracking system utilizes technology such as image scanning, image capture, scales, heat sensing, motion sensing, to detect information about a participant. This data may be tracked initially or updated over periods of time, and stored in short-term or long-term caches, databases, or other storage mediums. This data may then be used to track the participant throughout the environment. The data may be used to determine the identity of the participant, the actions of the participant, the supplemental components or enhancements possessed or carried by the participant. Such tracking data and information may be used to trigger particular effects or actions within the environment

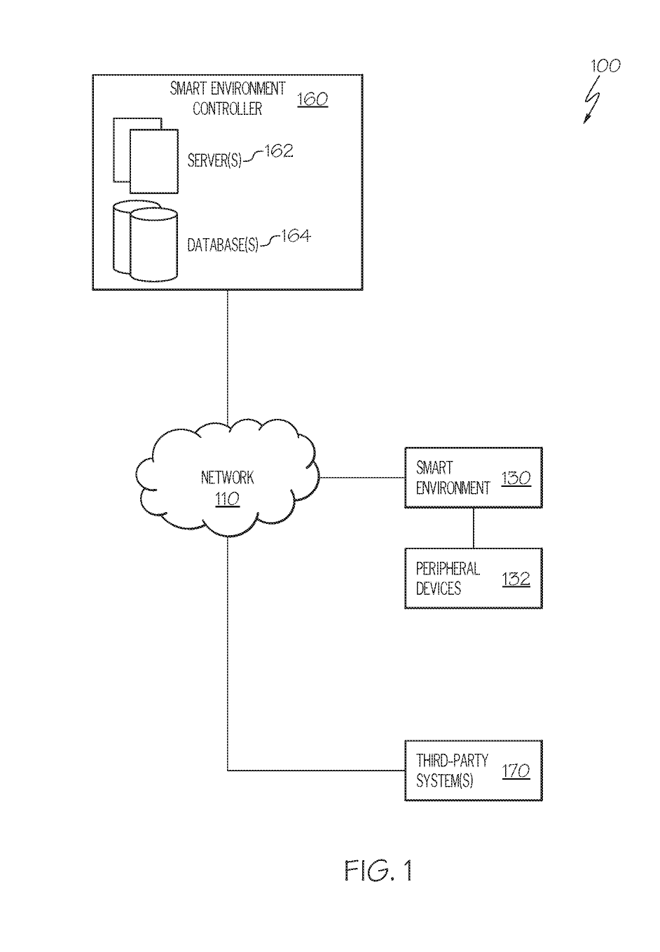

For example, with reference to FIG. 1, a block diagram depicting a system 100 for tracking information about a participant in an interactive environment is illustrated in accordance with a non-limiting embodiment of the present disclosure. System 100 includes tracking controller 160 which may be executed on or with access to server 162 and data store 164. Smart environment controller 160 is connected to smart environment 130 and third-party system 170 via network 110 and network links 150. Smart environment 130 includes a non-limiting example of various tracking devices 132 installed in the environment.

### Tacking Recognition

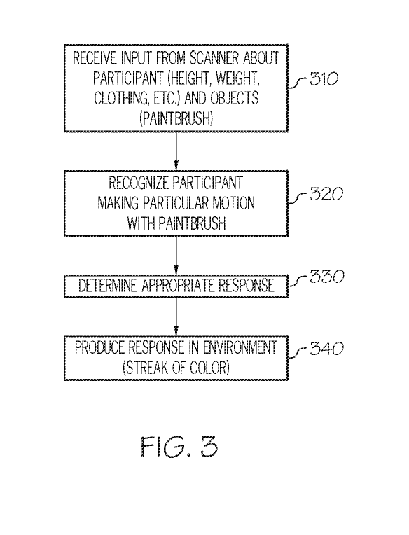

In certain embodiments, one or more computer processors are configured at a central server or computer to execute computer readable instructions for responding to the tracking information or data. A server, such as server 162 of FIG. 1, may execute the steps described in the flowchart of FIG. 3 for recognizing, reacting to, and providing adaptive interplay between tracking system and the participant with a non-limiting embodiment of the present disclosure. At step 310, information about the participant is determined. For example, the scanning device (such as a camera) determines that a particular participant has entered the environment and possesses a paintbrush. At step 320 the participant makes a gesture with the paintbrush object, and the processing software then processes the input, determines the appropriate response at step 330, and at step 340 returns the feedback in the form of a presentation of the streak of color across a visual interface.

In certain embodiments, information is determined about each attendee, participant, or user. For example, a camera may capture images of the participant's silhouette, or other attributes of the participant and attempt to identify the participant and distinguish from other participants based on those images. For example, the tracked information may include height, weight, size, hair color, clothing, shoes, etc. As another example, the scanning and participant information detection capabilities may be connected to outside processes or databases that further determine information regarding the participant and return that information to the controller for additional processing.

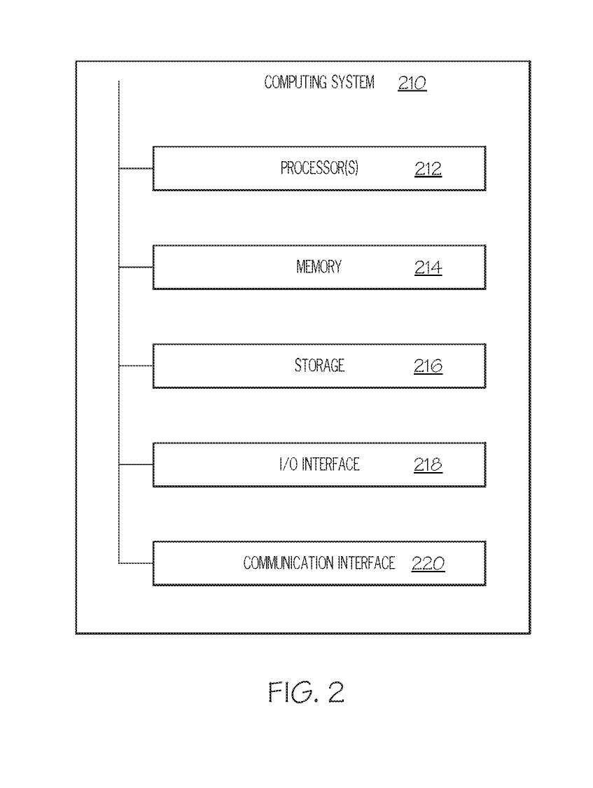

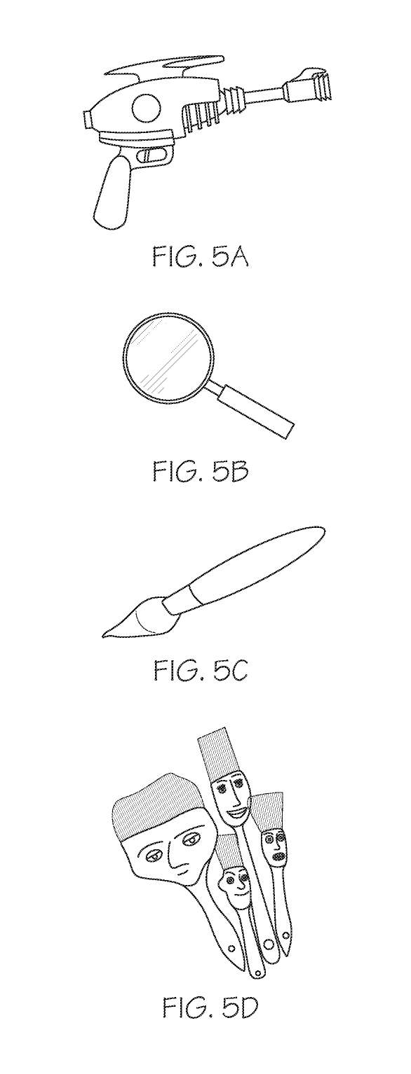

The participant may purchase or earn certain add-on items to enhance characteristics or abilities of the player or the avatar in the game environment. As depicted in FIGS. 5A-D, for example, embodiments of these add-on items include a blaster or gun (FIG. 2A), a magnifying glass (FIG. 2B), a pen (FIG. 2C), or a paintbrush (FIG. 2D), or other accessories (such as a sticker (coded or non-coded), clothing, jewels, rings, staffs, weapons, wands, books, tools, shields, or wings). Such special add-ons, features, clothing, or accessories may add features, functions, or abilities to the character. For example, in one embodiment, a player may purchase a blaster or gun (FIG. 2A), and the tracking system would recognize the blaster or gun, and the motion of the blaster or gun may be tracked, resulting in the virtual appearance of laser beams on a screen or in virtual or augmented reality within the environment. In another embodiment, the player may purchase a paintbrush (FIG. 2D), and the tracking system would recognize the paintbrush, and the motion of the paintbrush may be tracked, resulting in the virtual appearance of painted lines on a screen or in virtual or augmented reality within the environment. In yet another embodiment, for example, a player may purchase a magnifying glass (FIG. 2B), which can be recognized and tracked by the tracking system without the need for sensors or electronics built into the object, and upon the motion or positioning of the object, may result in the appearance of enlarged images on a screen or in virtual or augmented reality, or a display of additional information about an object within the environment. In yet another embodiment, a player may purchase or earn an article of clothing, which may provide for multiple enhancements of the participant's profile, such as increased magical abilities, invisibility, or replenished health.

In certain embodiments, emerging technology includes one or more of the following:
Facial recognition;
Voice and speech
recognition; Biometrics;
Artificial intelligence;
Intelligent maintenance;
Sensory haptic
feedback.

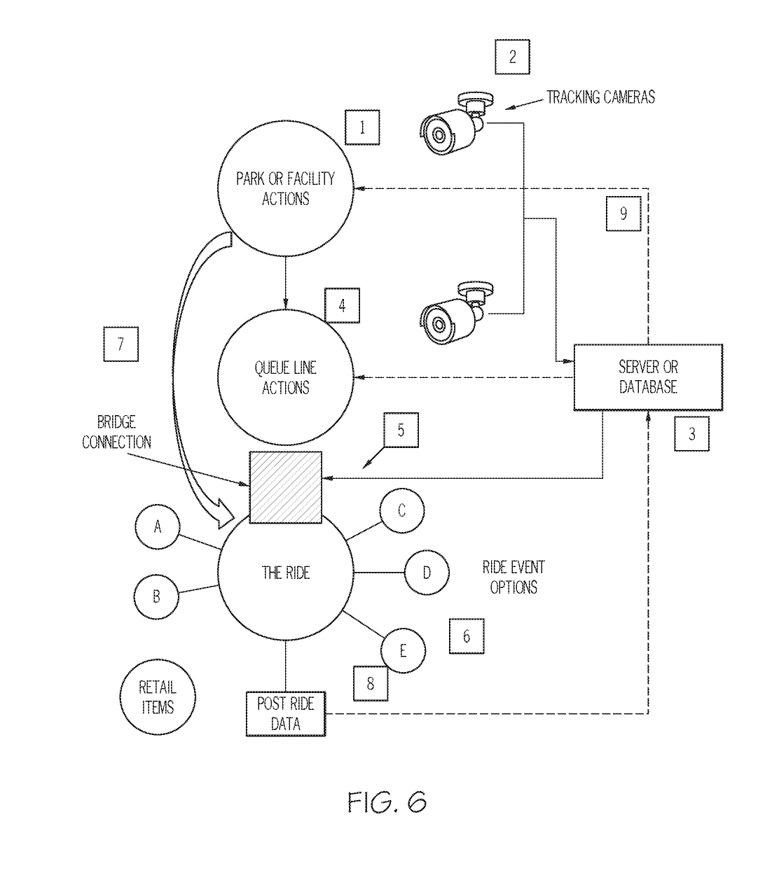

In certain embodiments, a smart tracking system can be implemented in a theme park environment in accordance with the configuration illustrated in FIG. 6. For example, the system uses tracking camera 2 and other tracking cameras located at various locations around a theme park or real-world attraction to surveil activities. The information captured by tracking camera 2 is related through a communication network 9 to server or data base 3. The server 3 can analyze the information and control various actions throughout the park. For example, a ride may be configured with various options A-E. The ride may also be equipped with sensors that receive input from users in the ride. For example, the server 3 may configure the ride with a special configuration, such as option C, for an identified user. The system may also transmit post ride data 8 to the server. In certain embodiments, the system can further identify and interact with users in line 4. The system may also recommend retail items 10 to a particular user based on one or more identified preferences or attributes of the user, or interactions between a user and various attractions or rides at the park.

In certain embodiments, tracking of a guest around the facility or park 1 can take place with RFID (intrusive) or camera (non-obtrusive) 2 means. The tracking system knows if they have completed certain games, quests, challenges or play elements and inputs that data into the server or database 3. Additional, subsequent or initial tracking can occur in the queue line to the ride 4 which data is also transmitted to the server 3. The server then communicates information to the bridge connection 5 as the guest enters the attraction, sits on the ride or the begins the ride, various options 6 that are initiated specifically for that guest because they completed the games, quests, challenges or play elements previously. In certain embodiments, a bridge connection, such as bridge connection 5 is an interface between the off-board and on-board actions of the guest. Here, guests can choose various actions, such as upgrades, levels, equipment, themes, scenery, stories, weapons, armor, actions, sensations, etc. This can be done inside of VR goggles, on a touch pad before the ride, on a touch pad during the ride, with hand gestures and many other means.

In certain embodiments, the ride may or may not have a queue line or this feature may not be used in the queue line so it is possible to access the bridge connection directly from actions around the park then getting onto the ride or entering the attraction, shown by arrow (7). Post Ride Data (8) such as the accomplishment of certain feats and actions while on the ride is also fed back into the server (dotted lines) which in turn create new games, quests, challenges or play element for the guest at the park or queue line (9). This can create an almost endless loop of changing games and quests in the park and queue line based on riders completing many rides or events. In certain embodiments, the rides and attractions may be stationary or moving. Retail items (10) can be bought virtually or real that the guest can also access on the ride such as weapons and armor or special abilities for a space vehicle.

### Unobtrusive Tracking

In certain embodiments, a tracking device comprises a digital video camera connected to a network and server computing device. The digital video camera captures images and/or video of guests at a theme park and transmits the captured images to the server. The server employs, for example, machine learning or other image processing technology to identify particular users in an area of the park corresponding to the coverage area of the camera. For example, one camera may be directed at the entrance of a theme park, while other cameras connected to the network are placed throughout the theme park.

In certain embodiments, the server may temporarily store digital images and other identifying information associated with the user for a given user while the user is at the park, and the system may automatically delete the identifying information when the user leaves. A wide variety of unobtrusive recognition technologies are implemented in accordance with the teachings of the present disclosure. For example, the information stored may only be maintained in a central data base for a limited amount of time. In certain embodiments, recognition technology is based on characteristics such as height, weight, hair color, clothing, shoes, etc., such that a unique identifying signature for a user is created based on these attributes to distinguish a guest from other guests on a particular day. For example, in one configuration, no username or personally identifiable information is stored other than these broad attributes. This may address user privacy concerns since the system may identify a user based on such traits as clothing color, since clothing color can be easily changed from one day to the next. Thus, in this embodiment, no personally identifiable information is stored and user activity tracking is limited to activities undertaken on a given day or series of days in a park.

In certain embodiments, the user tracking mechanisms can be optimized by the guest opting in and wearing stickers, badges, hats, t-shirts, bracelets, etc. that can make them even more recognizable. For example, in addition to clothing color and other physical attributes, a sticker or bracelet can provide an additional layer of recognition in addition to their human form and image.

In certain embodiments, the system identifies users and tracks user movements during a specific interval of time that could range from minutes to hours, days or years depending on how the guest choses to opt in and how the operations system wishes to engage them. In certain embodiments, all of that data about their movements and actions, which is non-specific to the person (no names, ages, email, etc.) is kept in an encrypted data base that only identifies them as a random player number. Their information can only be accessed by that person/player when they choose to by approaching a recognition station. For example, when a guest stands in the general area in front of a recognition station, their profile information of height, weight, clothing etc., is recognized by a camera at that station or mounted anywhere remotely and their data is accessed by the system. At that point they are given the choice by on-screen, voice or visual prompts to opt in to a deeper level of engagement at the park or ride. They can also be given the choice to create a fictitious or real name as well as add as much information as they want to their profile.

In certain embodiments, a user may complete some and/or all of their profile at home before they leave for the park on their computer, with an app or various other ways. For example, a user could download and print a sticker or button that they could wear to the park that would identify them. As another example, the user could wear a specific shirt or swim suit that the computer or phone's camera would capture that would then be recognized later at the park or resort.

In certain embodiments, guests may choose to opt in and opt out at various stations located all around the theme or water park. For example, a popular place to opt in may be at the beginning of the queue line for a ride or slide such as a roller coaster, dark ride, rapids ride, log flume, water slide, lazy river, etc. As the guest then travels thru the queue line they can engage in various games, missions or quests that will be recorded in the data base. Their achievements will result in various options and results in the ride that others who have not opted in to the play mode will not get on their ride.

In certain embodiments, the ride itself may be augmented in a number of ways such as buttons to push, video screens, virtual reality, augmented reality, mixed reality that are integrated into the Infinity Tracking system so that users of that system unlock various attributes on the ride such as:
A choice of vehicles, real or virtual
A choice of characters
A choice of clothing, weapons, armor, etc.
A variety of special abilities
A variety of missions and quests
Multiple levels and points including experience points, gold points, etc. as is common video games.

In certain embodiments, the teachings of the present disclosure aim to create a seamless game that can happen throughout a park, just on one ride or on a combination of rides that happens automatically, making it an easy and seamless experience for the end user.

In certain embodiments, the teachings of the present disclosure may be implemented within a ride or attraction. For example, the ride or attraction that is tracking and rewarding the player can be a motion-based ride, although the attraction can be a room-based attraction, stationary object, or space. In certain embodiments, user experiences are enhanced by enhancing the motion and quality of the ride experience in a way that was self-created by the guest therefore ultimately more rewarding, satisfying and personalized. For example, a user would be able to ride a vehicle of their choice and add the ability of firing photon blasters from their special space vehicle from a video screen, VR, AR or actual gun mounted on the vehicle because they completed a certain mini-game, quest or action in the queue line on the way to the ride. Or by completing the mini-game in the park, at home or on their phone. The game system at all of those locations will record their actions and activities without logging on, touching or activating anything. The gameplay device will be activated when they walk up to it and record their actions whether they have opted in or not. The ride will recognize them when they approach it and automatically give them the options that are activated by their actions beforehand.

In this embodiment, players would not need to “opt in” in order to get these benefits since Infinity Tracking is following them around the park regardless. The benefit of opting in is that the system will greet you by your registered name and know specifics of your profile that you have chosen to enter.

In certain embodiments, guests are notified when they enter the park either on their tickets, on signage and by other means that they can elect at any time to have their non-specific profile “untagged” and made invisible to the system. For example if a guest is 5′-9″, wearing a red shirt, blue pants, a black belt and white tennis shoes, player recognition files with those attributes will not be accessed any more during the next 24 hours by the infinity system. On the rare occasion that there are duplicates multiple files may be deleted but users or mistakenly deleted guests can always opt back in by standing in front of a recognition system. The deleting of identifiers is mainly a comfort feature for users. The system does not store or tracking any personal data on them and the image recognition info is encrypted so that no others can gain access to that information outside of the system regardless.

Another benefit of such a system is that one ride can take on many different themes, looks and actions all at the same time for different riders. For example, if the ride features a two-person vehicle in which the players are using video screens or virtual reality, one can be shown in a space vehicle while the other sees themselves as riding on the back of a dragon. Or one is experiencing Star Wars while the other is experiencing SpongeBob Square Pants. This is of huge benefit to the owner operator that can now market an attraction that appeals to a wider audience with different tastes for the price of just one ride.

The user can also carry wands, blasters (toy guns) and other objects that the Infinite Tracking system will recognize and “energize”. The objects can be simple and do not need to have tags or electronics in them. The game system will know what the object is capable of doing and show the appropriate spell, laser or bullet that would emanate from the object on the screen or in the headset. The player may also use other technologies that are embedded in the item to create other unique results, but the core technology of Infinity Tracking is the basis for the game play and results.

This benefit of recognizing and energizing simple toys to be complex items with different abilities in the game can be present on rides or without rides. For example, a player who buys a toy blaster with no specific technology embedded in it can suddenly shoot laser beams, lighting bolts or paint colors from the gun when they stand in front of a camera and screen utilizing the Infinity Tracking system. Similarly a wand that has no electronics embedded can cast amazing spells on the screen. Or a paintbrush can throw virtual paint onto a screen.

In the basic version of Infinity Tracking it is the “off-board” activation of effects while on-board the ride that is a key characteristic of the system. Examples of rides, games and results where players are riding and have special effects that were activated off-board in the park or queue line include at least the following:
A roller coaster
A log flume ride
A water slide
River Rapids ride
Inner tube ride
Any number of rides and attractions in theme and water parks.

Examples of ways items are activated include:
By earning virtual points or currency that is redeemed
By playing mini-games
By completing a scavenger hunt

In certain embodiments, players can, for example, shoot and score on their way down the ride with peripheral augmented reality glasses, such as Infinity Goggles, that are connected to the buttons on your raft to shot enemy dragons, aliens or jellyfish. For example, an a DragonRider game players can see themselves riding a certain color dragon, having special abilities to shoot multiple fireballs and wear clothing and armor that was earned off-board the game. In Spaceflight game players see themselves riding a space vehicle that is outfitted with the items that they earned or bought off-board. They can also be wearing special space suits and devices that they earned.

One of the keys to this ride effect system is that players feel the physical sensations of going around curves, dropping thru drops and going up or down hill simultaneous with their special vehicle powers.

In certain embodiments, the rides may also interface with MagiQuest and/or Parkwide gaming where the items you find scattered about all show up in your VR. Players can also buy virtual items and upgrades that gear your ride up even more.

In certain embodiments, waterslide effects can also be added for levels such as heat, wind and speed.

In certain embodiment, Imagine the ultimate waterslide tower with multiple dispatch at the top to various levels of slides. Some easy going, some fast with lots of drops. DragonRider can be various levels of GAME and SLIDE from the top. Players can earn gold on the way up to upgrade their dragon, weapons and armor. On feature can include showing the player and Dragon in 3rd person so you can see your armor, the head of the dragon and wings, etc. In certain embodiments, start tubs can be themed to match the story: Dragon, space, etc., so they are really launching. The vehicles can also be themed to match so they really look like the space vehicles. Only the attachments or special items are earned off-board. A storyline can explain why you are launching into a tube, even with dragons (time portal, etc.).

With reference to FIG. 2, a computing system 210 is illustrated in accordance with a non-limiting embodiment of the present disclosure. For example, computing system 210 may implement a smart tracking platform or system in connection with the example embodiments described in the present disclosure. Computing system 210 includes processors 212 that execute instructions loaded from memory 214. In some cases, computer program instructions are loaded from storage 216 into memory 214 for execution by processors 212. Computing system 210 additional provides input/output interface 218 as well as communication interface 220. For example, input/output interface 218 may interface with one or more external users through peripheral devices while communication interface 220 connects to a network. Each of these components of computing system 210 are connected on a bus for interfacing with processors 212 and communicating with each other.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A tracking system comprising:
A real-world interactive entertainment environment;
A recognition station whereby the system manually or automatically determines identifying information about an individual participant and/or associated objects based on distinguishing characteristics;
A database for storing the identifying information about individual participants or associated objects;
A plurality of sensors located throughout the interactive entertainment environment, comprising cameras, scanners, scales, biometric analyzers, retinal scanners, fingerprint sensors, or voice analyzers;
Whereby the sensors sense or detect tracking information of individual participants and/or associated objects, including the presence, movement, and/or activity of individual participants or the associated objects in the entertainment; and
A computer or processor determines an appropriate response based on the tracking information of the individual participant and/or associated objects and executes computer-readable instructions or software for responding to the tracking information.

2. The tracking system of claim 1 wherein the distinguishing characteristics comprise facial features, weight, height, hair color, eye color, clothing, or shoes.

3. The tracking system of claim 1 wherein the associated objects comprise a sticker, badge, bracelet, gun, magnifying glass, pen, paintbrush, orb, sword, with or without electronic tracking technology such as RFID chips

4. The tracking system of claim 1 wherein the user or participant can create a supplemental participant profile on-site or on-line, that can add additional information to the database, resulting in desired effects.

5. The tracking system of claim 4 wherein the appropriate response is displayed on virtual reality goggles to enhance the visual display within the interactive environment

6. The system of claim 1 wherein the system comprises a privacy mechanism to allow participants to anonymize, encrypt, or opt out of detection

7. An amusement park ride or attraction comprising:
A computer system that stores storyline, gameplay, or theme preferences entered by a user or participant through a communication interface before entering the amusement park ride or attraction;
A tracking system comprising sensors that captures, records, and stores identifying information about a user or participant and or associated objects;
A processor that distinguishes the user or participant from other users or participants based on the identifying information and assigns a unique identifier;
Wherein the storyline, gameplay, or theme preferences are assigned to the unique identifier;
Wherein the storyline, game play, or theme executed throughout the amusement park ride or attraction is modified to provide a customized experience based on the storyline, gameplay, or theme preferences assigned to the unique identifier.

8. The amusement park ride or attraction of claim 7 wherein the identifying information is deleted after the user or participant exits the amusement park ride or attraction.
